(19) United States
(12) Patent Application Publication
(10) Pub. No.: US 2011/0114472 A1
(43) Pub. Date: May 19, 2011

(54) PROCESS FOR PRODUCING GLUCOSAMINE AND ACETYL GLUCOSAMINE BY MICROWAVE TECHNIQUE

(76) Inventors: Ho-Shing WU, Jhongli City (TW); Bo-Cheng Lin, Jhongli City (TW); Azis Boing Sitanggang, Jhongli City (TW)

(21) Appl. No.: 12/620,379

(22) Filed: Nov. 17, 2009

(51) Int. Cl. C08G 73/02

(52) U.S. Cl. 204/157.69

(57) ABSTRACT

A process for producing glucosamine and acetyl glucosamine by using microwave technique, comprising following steps: (1) providing a chitin or chitosan source formed by a microorganism; (2) adding hydrochloric acid solution having concentration of 2N˜6N into said chitin or chitosan source to form a reaction solution; (3) placing said reaction solution in a microwave device and heating therein at power of 700˜2100 watt to carry out hydrolytic reaction such that chitin or chitosan is hydrolyzed into glucosamine or acetyl glucosamine.

### BACKGROUND OF THE INVENTION

1. Field of the Invention

The invention relates to a process for producing glucosamine and acetyl glucosamine, and in particular, to a process for producing glucosamine and acetyl glucosamine by using microwave device as the hear source of a hydrolytic reaction to hydrolyze chitin or chitosan.

2. Brief Description of the Prior Art

Glucosamine (GlcN), or 2-amino-2-deoxy-D-Glucose, is one of the ingredients of articular cartilage, and plays roles for providing nutrients to articular tissue, enhancing the capability of synovial fluid to restore lubrication function of, promoting the regeneration of dysplastic joint, reducing effectively the pain caused by bone friction and further preventing the deterioration of arthritic symptom. Glucosamine can be synthesized by human body itself. However, as the age increased, the rate of synthesizing glucosamine by human body becomes lower than that of decomposing glucosamine, such that glucosamine deficiency in the body and joint tends to occur, and the metabolism of intra-articular cell may be affected.

Glucosamine or its acetylated derivative N-acetyl glucosamine (GlcNAc) possesses following features: (1) stimulating the neogenesis of chondrioblast, promoting its metabolism, providing nutrients to bone, reducing inflammation, and vanishing pain; (2) protecting cartilage cell from being damaged by drug or external force, and preventing degeneration of articular joint; (3) increasing the quantity and viscosity of synovial fluid, promoting the lubrication function of joint, improving function of osteo-arthrite; (4) improving sore waist and aching back. In Europe, glucosamine has been used extensively in the treatment of arthritis. After ingesting glucosamine, human body can absorb quickly, deliver to various tissues and utilized thereby. Rate acute toxicity test and microbial mutagenecity assay had demonstrated that glucosamine is a safe and nontoxic health food, and an effect of preventing arthritis can be achieved by supplementing glucosamine early.

Since glucosamine and acetyl glucosamine possess a number of above-mentioned medical functions and advantages, a lot of health food or supplemental tablets with glucosamine as main ingredient have been appeared in the market. The research and development on the process for producing glucosamine as well as its improvement become one of important topics of many pharmaceutical factories. Because glucosamine and acetyl glucosamine are monomers constituting chitin and chitosan, in a traditional industry, processes for producing glucosamine and acetyl glucosamine have been based on the acidic or enzymatic hydrolysis of chitin or chitosan. These processes comprise: soaking shrimp shell powder or crab shell powder in hydrogen chloride solution to remove calcium carbonate, and then, cooking with alkali to remove fat and protein, the product thus-obtained is chitin; thereafter, soaking said chitin in hydrogen chloride solution till chitin is dissolved into liquid phase, and then, adding active carbon to remover color and heavy metal; finally, after concentration, crystallization, alcohol washing, and low temperature vacuum drying, a white crystalline powder of glucosamine can be obtained.

However, in the above-described process, shrimp or crab shell powders from different sources will influence the purity of glucosamine. Further, if source of shrimp or crab has been contaminated by toxic substance, the glucosamine made therefrom may have toxicity. In addition, before hydrolyzing shrimp or crab shells, labor must be spent to wash said shrimp or crab shells to avoid fetor. Furthermore, glucosamine is not the only one product obtained in the hydrolysis of shrimp or crab shells, the hydrolysate must be purified to isolate glucosamine from other by-products.

In addition to the above-described processes for producing glucosamine or acetyl glucosamine by hydrolytic method using shrimp or crab shell powders as chitin or chitosan sources, there is other process for producing glucosamine or acetyl glucosamine by using microorganism, such as the process using fungus, since cell wall of these fungi consists of chitin or chitosan, these fungi can be used as the source of chitin or chitosan. These processes comprise of isolating chitin or chitosan after breaking fungal cell, and carrying out hydrolytic reaction with hydrochloric acid to obtain glucosamine or acetyl glucosamine product.

In the above-described hydrolytic reaction with hydrochloric acid, reaction temperature and concentration of hydrochloric acid play important roles. The reaction time needed and the yield of glucosamine or acetyl glucosamine product will be varied due to differences of hydrochloric acid concentration and reaction temperature. In general, under condition of a reaction temperature of 60° C. to 100° C. and hydrochloric acid concentration of 10˜40% (w/w), the reaction time will be varied from tens minutes to 24 hours.

In a paper of Hsieh et al. (2007) published in Biotechnology Progress (Hsieh, J. W., H. S. Wu, Y. H. Wei, and S. S. Wang. 2007. Determination and kinetics of producing glucosamine using fungi, Biotechnol. Prog., 23: 1009-1016), a reaction condition with hydrochloric acid had been disclosed as followed:

| | | Hydrochloric | acid |
|---|---|---|---|
| Heating device | Temperature | concentration | Reaction time |
| Conventional oven | 100° C. | 6N | 24 hours |

The reaction condition with hydrochloric acid disclosed by Cao et al. in US. Patent Pub. No.: US 2008/0188649 A1 was as followed:

| | | | Hydrochloric | acid | |
|---|---|---|---|---|---|
| Chitin source | Temperature | | concentration | Reaction time | |
| Dried fungal (biomass) | 100° | C. | 20% 250 ml | 2 | hours |
| 100 g | 100° | C. | 31% 300 m1 | 2.5 | hours |

Gandhi et al. in their U.S. Pat. No. 6,486,307 B1 disclosed a reaction condition with hydrochloric acid as followed:

| | Reaction | Hydrochloric | acid |
|---|---|---|---|
| Chitin source | temperature | concentration | Reaction time |
| shrimp or crab shell | 95° C. | 36% 65 ° C. 200 g | 75 minutes |
| powders 100 g | | | |

Deng et al. in US. Patent Pub. No.: US 2004/0091976 A1 disclosed that the reaction rate of the hydrolysis of chitin with hydrochloric acid could be correlated with reaction temperature, concentration of glucosamine or acetyl glucosamine in the reaction solution, and the concentration of hydrochloric acid solution. Successful reaction condition included a reaction temperature of 60˜100° C., while reaction time would vary with reaction temperature and hydrochloric acid concentration, wherein the reaction time under high hydrochloric acid concentration and high reaction temperature would be 10 minutes, whereas reaction time under low hydrochloric acid concentration and low reaction temperature would vary from 3 hours to 24 hours.

It can be known from the above-described conventional techniques that time needed for producing glucosamine or acetyl glucosamine by acidic hydrolytic reaction varies from tens minutes to 24 hours. It is well-known that in a industrialized mass production process, the longer the reaction time needed in the production process is, personal working time needed will be longer, and the yield become lower, which does not favor the lowering of the production cost.

In view of the foregoing, the above-described conventional processes for producing glucosamine and acetyl glucosamine have many disadvantages, not a perfect-designed process and needed to be improved urgently.

In the light of the various disadvantages derived from the above-described conventional processes, inventor of this application had devoted to improve and innovate, and finally, after studying intensively for many years, had developed successfully a process for producing glucosamine and acetyl glucosamine by using microwave technique according to the invention.

### BRIEF DESCRIPTION OF THE DRAWINGS

FIG. 1 is a flow chart showing the process for producing glucosamine or acetylglucosamine through hydrolytic reaction with hydrochloric acid according to the invention;

FIG. 2 shows results of glucosamine content in samples obtained from the hydrolytic reaction by heating in a conventional oven (100° C.) used as the heat source device and adding HCl solution of various concentrations: (◯) 6 N HCl; (∇) 4 N HCl; (□) 2 N HCl;

FIG. 3 shows results of glucosamine content in samples obtained from the hydrolytic reaction by heating in a microwave oven (100% power, 1400 watt) used as the heat source device and adding HCl solution of various concentrations: (◯) 6 N HCl; (∇) 4 N HCl; (□) 2 N HCl;

FIG. 4 shows results of glucosamine content in samples obtained from the hydrolytic reaction by heating in a microwave oven used as the heat source device at various powers and adding 6 N HCl solution: (◯) 80% power (1120 watt); (∇) 90% power (1260 watt); (□) 100% power (1400 watt).

### SUMMARY OF THE INVENTION

The object of the invention is to provide a process for producing glucosamine and acetyl glucosamine by using microwave technique. Present industrial process for producing glucosamine has been based still on the hydrolysis of chitin or chitosan with hydrochloric acid, which is time-consumed and wastes energy, the next step can be carried out only after the hydrolytic reaction with hydrochloric acid is completed. In view of this, the object of the invention is to provide a hydrochloric acidified process that can save reaction time and energy remarkably, the reaction time of hydrochloric acidification reaction of several hours can be shorten to complete in 3 minutes, which can save further energy and lower production cost.

In order to achieve the above-described object, the inventor uses the electromagnetic energy of microwave as the heating energy to promote effectively and rapidly the chemical reaction. Microwave technique can helps engineer shortening cost remarkably, accelerating reaction rate, increasing yield and the like. Therefore, the present invention utilizes microwave technique in the hydrolytic reaction of fungal biomass to produce glucosamine or acetyl glucosamine, which, under acidic environment, can reduce acidification reaction time, as well as save energy and production cost.

step 1: providing a chitin or chitosan source;

step 2: adding acid solution into said chitin or chitosan source to form a reaction solution;

step 3: placing said reaction solution in a microwave device and heating therein to carry out hydrolytic reaction such that chitin or chitosan is hydrolyzed into glucosamine or acetyl glucosamine;

The process for producing glucosamine and acetyl glucosamine by using microwave technique that can achieve the above-described object of the invention comprises following steps:

### Step 1

wherein said chitin or chitosan source is a microorganism that can produce chitin or chitosan; said microorganism is one selected from the group consisting of Rhizopus oligosorus BCRC 31996, Monascus purpures BCRC 31499, Monascus pilosus BCRC 31527 or Aspergillus sp. BCRC 31742. In a preferred embodiment, said microorganism is a Aspergillus flavus, Aspergillus sp. BCRC 31742.

Wherein said acid solution is a hydrochloric acid solution or sulfuric acid solution. In a preferred embodiment, said acid solution is a hydrochloric acid solution; wherein the concentration of said hydrochloric acid solution is 2N to 6N. In another preferred embodiment, the concentration of said hydrochloric acid solution is 6N.

Wherein the power of said microwave device is 700 watt to 2100 watt. In a preferred embodiment, the power of said microwave device is 1120 watt to 1400 watt; in another preferred embodiment, the power of said microwave device is 1400 watt.

Wherein the heating time in the step 3 is 90 seconds to 270 seconds; in a preferred embodiment, said heating time is 180 seconds to 270 seconds; in another embodiment, when the concentration of hydrochloric acid solution is 6N, said heating time is 180 seconds.

### DESCRIPTION OF THE PREFERRED EMBODIMENTS

### Example 1

### Preparation of Chitin or Chitosan Source

This example cultivates massively a chitin- or chitosan-producing fungus in shaking flask fermentation fashion, uses this fungus as the source of chitin or chitosan, breaks fungal cell, isolates chitin or chitosan, and finally, carries out hydrolytic reaction with hydrochloric acid to obtain glucosamine or acetyl glucosamine product.

### 1.1 Test Strain

This example uses Aspergillus flavus, Aspergillus sp. BCRC31742 as the strain for producing fungal biomass. Said strain had been purchased from Food Industry Research And Development Institute (Hsinchu, Taiwan).

### 1.2 Cultivation by Shaking Flask Fermentation

Aspergillus flavus strain Aspergillus sp. BCRC31742 was cultured in a PDA solid medium (Potato Dextrose Agar: 200 g/L Diced potatoes, 20 g/L Glucose, 15 g/L Agar) at 30° C. to be activated for 7 days. Then, a single colony was inoculated in a sterilized PDB liquid medium (Potato Dextrose Broth: 20 g/L Diced potatoes, 4 g/L Glucose, 150 ml) and cultured at 30° C. and rotation speed of 200 rpm for 7 days to perform second activation. Next, shaking flask cultivation was carried out. The activated strain was inoculated in a sterilized GP medium (glucose peptone medium: 25 g/L Glucose, 20 g/L Peptone, 0.5 g/L KH₂PO₄, 0.5 g/L MgSO₄.7H₂O, 0.1 g/L CaCl₂.2H₂O), and cultivated at 30° C. and a rotation speed of 200 rpm for 7 days. After the shaking flask fermentation, the fungus fermentation product (fungal biomass) thus-obtained was isolated from the medium through vacuum filtration, and was washed several times with sterile water. Said fungal biomass was dried in an oven and weighed. Then, the dried fungal biomass was re-suspended in 10 ml sterile water, and the fungal cell was broken in a homogenizer. The lysate was used as chitin or chitosan source in hydrolytic reaction test described in Example 2.

### Example 2

### Hydrolytic Reaction Test with Hydrochloric Acid

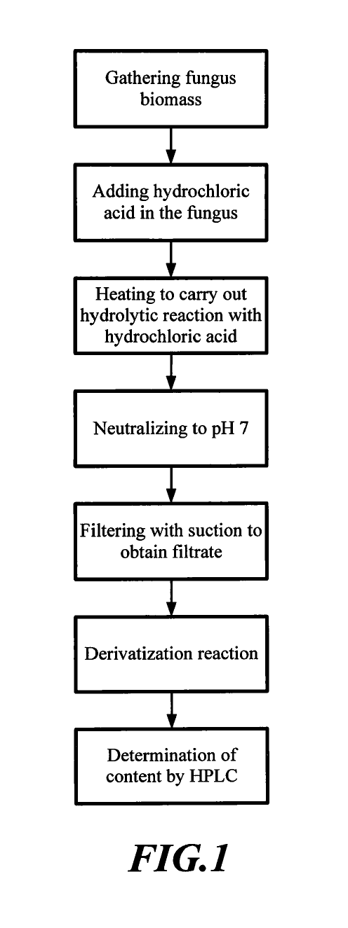

Hydrolytic reaction test with hydrochloric acid was carried out in accordance with the flow scheme as described as in FIG. 1. Fungal biomass prepared in Example 1 was used as a chitin or chitosan source. After adding hydrochloric acid thereinto, hydrolytic reactions were carried out under various reaction conditions to obtain glucosamine or acetyl glucosamine product. Then, 1-naphthyl isothiocyanate pyridine (1-NITC) solution was added therein to perform derivatization reaction. The content of glucosamine was then determined by High Performance Liquid Chromatography (HPLC).

2.1 Test with Conventional Oven as the Heat Source

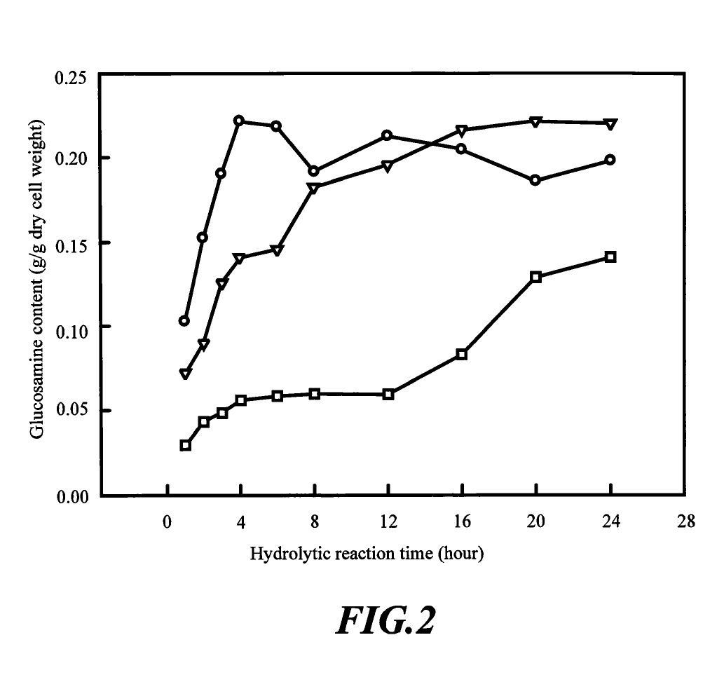

Each sample used 10 ml homogenized fungal cell solution as test material and to which, 10 ml each of various concentrations of 2N, 4N, and 6N hydrochloric acid (HCl) solution was added, respectively, mixed well and placed in a conventional oven at 100° C. for reacting by heating for 1, 2, 3, 4, 6, 8, 12, 16, 20, and 24 hours, respectively. To each sample, 10 ml of sterile water was added to terminate the reaction. After cooled to 30° C., each reaction solution was neutralized with 12N sodium hydroxide (NaOH) solution to pH 7.0. The resulted solution was filtered through a 45 μm filtering membrane. 0.1 ml of the filtered reaction solution was used in a derivatization reaction, and the content of glucosamine was determined by HPLC. Results were shown in FIG. 2.

2.2 Test with Microwave Oven as the Heat Source

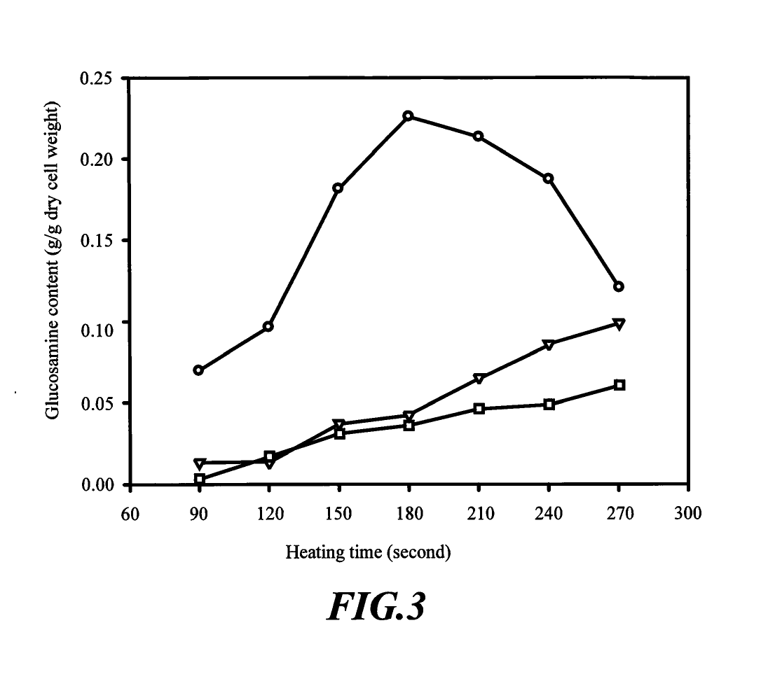

Each sample used 10 ml homogenized fungal cell solution as test material and to which, 10 ml each of various concentrations of 2N, 4N, and 6N hydrochloric acid (HCl) solution was added, respectively, mixed well and placed in a microwave oven. Reaction was carried out by heating at 100% power (1,400 watt) for 90, 120, 150, 180, 210, 240, and 270 seconds, respectively. To each sample, 10 ml of sterile water was added to terminate the reaction. After cooled to 30° C., each reaction solution was neutralized with 12N sodium hydroxide (NaOH) solution to pH 7.0. The resulted solution was filtered through a 45 μm filtering membrane. 0.1 ml of the filtered reaction solution was used in a derivatization reaction, and the content of glucosamine was determined by HPLC. Results were shown in FIG. 3.

2.3 Test with Various Microwave Powers

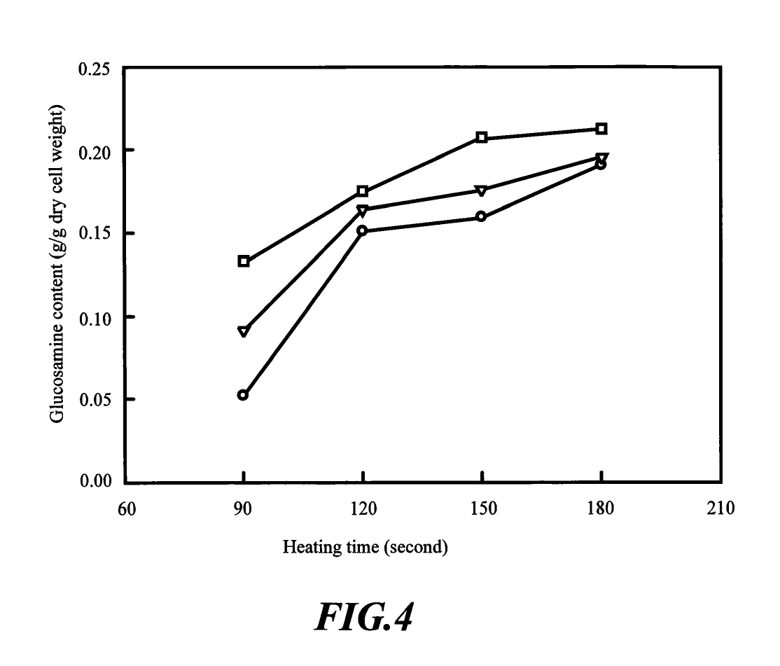

Each sample used 10 ml homogenized fungal cell solution as test material and to which, 10 ml of 6N hydrochloric acid (HCl) solution was added, mixed well. Each mixture was placed in a microwave oven, and reaction was carried out by heating at 80% power (1120 watt), 90% power (1260 watt), and 100% power (1,400 watt) for 90, 120, 150, and 180 seconds, respectively. To each sample, 10 ml of sterile water was added to terminate the reaction. After cooled to 30° C., each reaction solution was neutralized with 12N sodium hydroxide (NaOH) solution to pH 7.0. The resulted solution was filtered through a 45 μm filtering membrane. 0.1 ml of the filtered reaction solution was used in a derivatization reaction, and the content of glucosamine was determined by HPLC. Results were shown in FIG. 4.

### 2.4 Derivatization Reaction

Reaction solutions obtained by hydrolytic reaction under various condition in the above-described 2.1, 2.2, and 2.3 tests was used in a derivatization reaction. To 0.1 ml each of said reaction solutions, 0.3 ml of 40 mol/m³ 1-NITC solution was added, and the mixture was reacted at 50° C. and a rotation speed of 100 rpm for 1 hour to form glucosamine hydrochloride derivative. After the reaction, 0.1 ml of HPLC internal standard [0.1% (wt) 3,5-dinitrobenzonitrile dissolved in acetonitrile] was added, filtered and 10 μL, was taken for the determination of glucosamine content.

### 2.5 Determination of Glucosamine Content by High Performance Liquid Chromatography (HPLC)

The content of glucosamine content was determined by HPLC under following analytical conditions:

HPLC pump: Shimadzu LC-10AS

Column: LiChrospher® 100 RP-18 (5 μm, 4 mm i.d.×250 mm)

Column temperature: 40° C.

Mobile phase: water/acetonitrile (87/13), both water and acetonitrile were HPLC grade

Flow rate: 1.3 ml/min

Detector: Uv-V is detector SPD-10A, 0.0100 AUFS (Simadzu, Japan)

Pressure: 130˜150 kgf

UV detection wavelength: 230 nm

UV detection time: 40 minutes

Then, peak area ratio of glucosamine hydrochloride derivative to internal standard was substituted in the glucosamine hydrochloride calibration curve of peak area ratio of glucosamine hydrochloride derivative to internal standard to find number of grams of glucosamine by intrapolation, which was converted into the content of glucosamine ingredient (GluN Content). Contents of glucosamine ingredient thus-determined in each of 2.1, 2.2, and 2.3 tests were shown in FIGS. 2, 3 and 4, respectively.

It could be known from the result shown in FIG. 2 that, in the case of using conventional oven as the heat source, samples added with 6N HCl had its highest glucosamine content (0.22 g/g dry cell weight) after heating for 4 hours; samples added with 4N HCl had its highest glucosamine content (0.22 g/g dry cell weight) after heating for 24 hours; whereas samples added with 2N HCl had its highest glucosamine content (0.14 g/g dry cell weight) after heating for 24 hours.

It could be known from the result shown in FIG. 3 that, in the case of using 100% power (1400 watt) microwave oven as the heat source, sample added with 6N HCl had its highest glucosamine content (0.22 g/g dry cell weight) after heating for 180 seconds (3 minutes); samples added with 4N HCl had its highest glucosamine content (about 0.10 g/g dry cell weight) after heating for 270 seconds (4.5 minutes); whereas samples added with 2N HCl had its highest glucosamine content (0.06 g/g dry cell weight) also after heating for 270 seconds (4.5 minutes).

Further, as shown in FIG. 4, in the case of carrying out hydrolytic reaction with 6N HCl solution and using microwave oven at various powers as the heat source, samples had its highest glucosamine content (about 0.18 g/g dry cell weight) after reacting by heating for 180 seconds (3 minutes) at 80% power (1120 watt) microwave; likewise, samples had its highest glucosamine content (about 0.19 g/g dry cell weight) after reacting by heating for 180 seconds (3 minutes) at 90% power (1260 watt) microwave; whereas samples had its highest glucosamine content (about 0.22 g/g dry cell weight) after reacting by heating for 180 seconds (3 minutes) at 100% power (1400 watt) microwave.

It is obvious from the test results of this example that the process for producing glucosamine by using microwave technique provided by the invention can shorten the reaction time needed in the hydrolytic reaction using hydrochloric acid from several hours to 3 minutes. The comparison between conventional and the present hydrochloric acid hydrolytic reaction processes is shown as followed. It is obvious that in the present invention, performing hydrolytic reaction with hydrochloric acid by using microwave technique can shorten effectively the reaction time, as well as lower cost of energy consumption.

| Heat source device | Reaction time | |
|---|---|---|
| Conventional oven | 10 | minutes~24 hours |
| Microwave oven | 3 | minutes |

The process for producing glucosame and acetylglucosame by using microwave technique provided by the invention has following advantages over other conventional techniques:

1. The greatest difference between hydrochloric acid hydrolysis of the invention and the conventional technique is that conventional hydrochloric acid hydrolysis must take place in an oven at high temperature (60° C.˜100° C.) for several hours (generally about 4˜24 hours); while the process according to the invention gets rid of conventional oven, and uses microwave oven instead in the hydrolysis with hydrochloric acid, which can shorten effectively the reaction time, and achieve same effect as that of the conventional process needing only about 3˜10 minutes.

2. The process using microwave technique provided according to the invention can operate simply, and has less steps and shorter reaction time (completed only within 3˜10 minutes). If the process of the present invention is applied in the industrialized mass production of glucosamine or acetylglucosamine, cost of heat energy consumption in the production process can be reduced remarkably, process time can be shortened greatly, yield can be increased, and thus lower the production cost of glucosamine or acetylglucosamine.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A process for producing glucosamine and acetyl glucosamine by using microwave technique, comprising following steps:
step 1: providing a chitin or chitosan source;
step 2: adding acid solution into said chitin or chitosan source to form a reaction solution;
step 3: placing said reaction solution in a microwave device and heating therein to carry out hydrolytic reaction such that chitin or chitosan is hydrolyzed into glucosamine or acetyl glucosamine.

2. A process for producing glucosamine and acetyl glucosamine by using microwave technique as recited in claim 1, wherein said chitin or chitosan source is a microorganism that can produce chitin or chitosan.

3. A process for producing glucosamine and acetyl glucosamine by using microwave technique as recited in claim 2, wherein said microorganism is one selected from the group consisting of Rhizopus oligosorus BCRC 31996, Monascus purpures BCRC 31499, Monascus pilosus BCRC 31527 or Aspergillus sp. BCRC 31742.

4. A process for producing glucosamine and acetyl glucosamine by using microwave technique as recited in claim 1, wherein said acid solution is hydrochloric acid solution or sulfuric acid solution.

5. A process for producing glucosamine and acetyl glucosamine by using microwave technique as recited in claim 4, wherein said hydrochloric acid solution has a concentration of 2N to 6N.

6. A process for producing glucosamine and acetyl glucosamine by using microwave technique as recited in claim 1, wherein the power of said microwave device is 700 watt to 2100 watt.

7. A process for producing glucosamine and acetyl glucosamine by using microwave technique as recited in claim 1, wherein the heating time in said step 3 is 90 seconds to 270 seconds.
